(19) United States
(12) Patent Application Publication
(10) Pub. No.: US 2015/0170245 A1
(43) Pub. Date: Jun. 18, 2015

(54) MEDIA CONTENT INSTANCE EMBEDDED PRODUCT MARKETING

(71) Applicant: DFS Medialabs, LLC, Scottsdale, AZ (US)

(72) Inventor: Damian Felice Scoglio, Hermosa Beach, CA (US)

(73) Assignee: DFS Medialabs, LLC, Scottsdale, AZ (US)

(21) Appl. No.: 14/106,381

(22) Filed: Dec. 13, 2013

(51) Int. Cl. G06Q 30/06; G06Q 30/02

(52) U.S. Cl. CPC G06Q 30/0623; G06Q 30/0257

(57) ABSTRACT

A device may capture a portion of a scene of a media content instance and may provide the portion to an inspector server. The inspector server may provide a representative image corresponding to the scene and item identifiers of at least one item included in the scene that are available for purchase. The device may display the representative image and an overlay visible over the representative image, the overlay including interactive image tag corresponding to items available for purchase and location indications presented at locations in the representative image where the corresponding items appear. Using the overlay, the device may select to purchase an item included in the scene.

### TECHNICAL FIELD

The present disclosure relates to a method, a non-transitory computer readable medium, system and an apparatus for marketing of products that are placed or otherwise present in instances of media content.

### BACKGROUND

When viewing media content such as television programming, a consumer may view items in a scene of media content that he or she may wish to purchase. As an example, a character on a television sit-com program may be wearing an item of clothing of interest to the viewing consumer. In many cases, the customer may be unable to identify the item of interest from the programming. Moreover, even in cases where the customer is able to identify the item, the customer may be unable to determine from where the item may be purchased. Thus, while product placement may be performed in media content, at present it may be difficult for the placed products to be identified and purchased by consumers.

### SUMMARY

A client device may capture a portion of a scene of a media content instance and may provide the captured portion to an inspector server. The inspector server may provide a representative image corresponding to the scene and item identifiers of at least one item included in the scene that are available for purchase. The client device may display the representative image and an overlay visible over the representative image, the overlay including interactive image tags corresponding to items available for purchase and presented at locations in the representative image where the corresponding items appear. Using the overlay, the client device may select to purchase an item included in the scene.

### BRIEF DESCRIPTION OF THE DRAWINGS

FIG. 1 illustrates an exemplary block diagram of a system for providing information on products present in media content instances.

FIG. 2A illustrates a user interface of an inspector application capturing a portion of an instance of media content.

FIG. 2B illustrates an exemplary user interface of an inspector application including a representative image and item overlay.

FIG. 2C illustrates an exemplary user interface of the inspector application including an item information interface element.

FIG. 2D illustrates an exemplary user interface of the inspector application including a shopping cart feature.

FIG. 3 illustrates an exemplary process for providing information on products present in media content instances.

FIG. 4 illustrates an exemplary process for performing actions on products present in media content instances.

FIG. 5 illustrates an exemplary process for identifying and performing actions on selected products present in media content instances using a client device.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and made part of this disclosure.

A user who is experiencing a television program or other instance of media content may desire information regarding products that appear in the media content instance. To obtain the information, the user may utilize an inspector application executed by a communication device to capture a portion of the audio and/or video content of the presented media content instance. The captured portion may then be provided by the inspector application to an inspector server for identification. The inspector server may identify a scene of the media content instance being experienced, and may provide to the inspector application one or more representative images corresponding to the identified scene along with positional and other item information. The communication device may use the provided information to present the representative image of the scene, along with an item overlay identifying which items in the scene are available for purchase, as well as where the items are included in the scene.

The inspector server may receive the captured portion from the communication device, and may use audio and/or video recognition technology to identify the media content instance being experienced by the user. As one example, the inspector server may identify captured portion as being part of a scene of an episode of a television program. To allow the inspector server to identify captured portions of media content instances, the inspector server may receive feeds of media content instances from media content distributors (e.g., production partners) for scene indexing. Moreover, to identify the information regarding products that appear in the media content instances, the inspector server may further access a scene information data store including item information indexed by scene. Accordingly, based on the identified captured portion, the inspector server may retrieve and provide additional information to the user regarding products that appear in the content.

The inspector application may display the received additional information to the user, allowing the user to interact with a display of items for sale within the context in which they are seen within the media content instance. The inspector application may further allow the user to perform various operations based on the displayed content, such as view additional information about the displayed products, select one or more items for purchase, mark one or more scenes or items as favorites to be revisited at a later time, and share favorite items or scenes with others users.

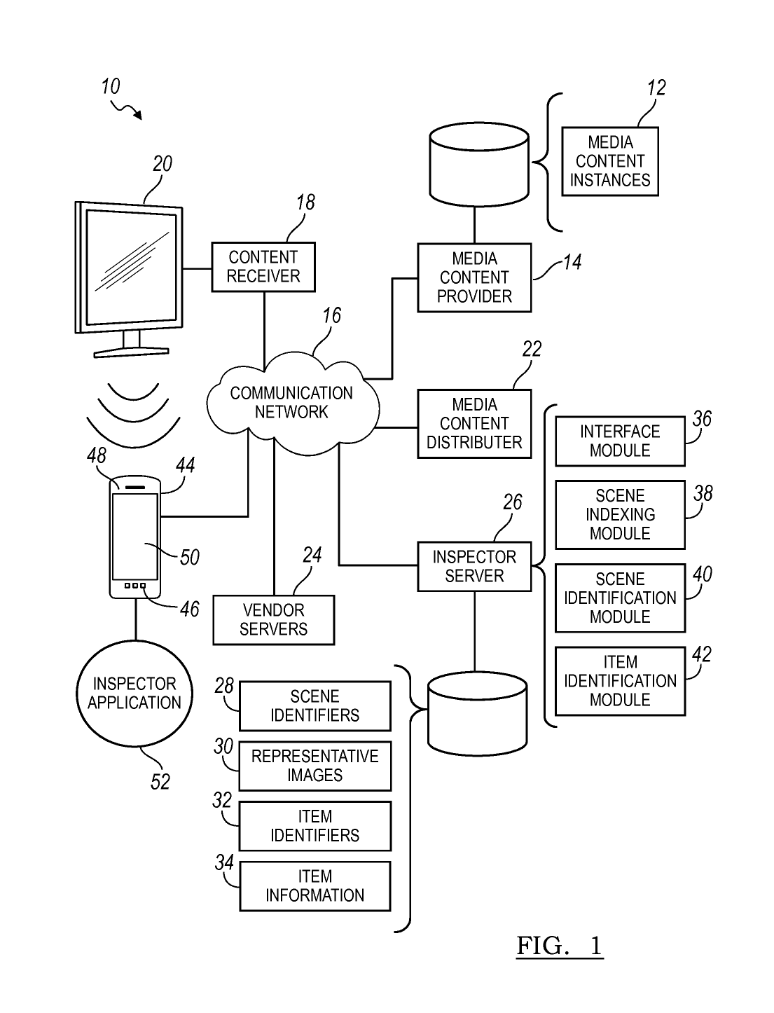

FIG. 1 illustrates an exemplary block diagram of a system 10 for providing information on products present in media content instances 12. The system 10 may include a communication network 16 over which a media content provider 14 may provide media content instances 12 to one or more content receivers 18 for display on associated display devices 20. The system 10 may further include one or more media content distributors 22 configured to provide media content instances 12 to the media content provider 14 for distribution, as well as one or more vendor servers 24 configured to provide advertisements or other product placement and purchase services regarding advertised products or services. The system 10 may also include an inspector server 26 configured to receive the media content instances 12 from the media content distributors 22 (or the media content provider 14) as well as to maintain scene identifiers 28, representative images 30, item identifiers 32 and item information 34 regarding products included in the media content instances 12. The system 10 may also include a client device 44 including input hardware 46 and output hardware 48 creating a user interface 50 of the device 44. The client device 44 may be configured to execute an inspector application 52 to capture portions of media content instances 12 displayed on the display device 20, provide requests to the inspector server 26 for information on products present in media content instances 12, and retrieve representative images 30, item identifiers 32 and item information 34 for display and further interaction in a user interface 50 of the client device 44. The vendor servers 24 may be further configured to perform purchases of items according to the item identifiers 32. The system 10 may take many different forms and include multiple and/or alternate components and facilities. While an exemplary system 10 is shown in FIG. 1, the exemplary components as illustrated is not intended to be limiting, and additional or alternative components and/or implementations may be used.

A media content instance 12 may refer to a television program or episode, motion picture film, online video content, or any other digital or analog video content. In some cases the media content instance 12 may include both audio and video content, while in other cases the media content instance 12 may include audio content but not video, or video content but not audio. In many cases, the media content instances 12 may further be associated with metadata descriptive of the content of the media content instances 12, such as program name, season number, principal actor(s), year of production, and episode number, as some examples. Products may be deliberately placed within scenes of media content instances 12, e.g., as part of an embedded marketing strategy, or may otherwise happen to be present in the media content instances 12 during production.

The media content provider 14 may be configured to maintain the media content instances 12, and to distribute the media content instances 12 over the communication network 16 to be received and experienced by consumers. Exemplary media content providers 14 may include over-the-air broadcast radio systems, cable systems, and Internet-protocol based media systems that provide streaming or downloadable content over the Internet. The communication network 16 may include one or more interconnected communication networks such as the Internet, a cable television distribution network, a satellite link network, a local area network, a wide area networks, and a telephone network, as some non-limiting examples.

The content receivers 18 may include various types of device configured to receive and decode media content instances 12 from media content providers 14. As one possibility, the media content provider 14 may provide media content instances 12 from a cable television head-end or an over-the-air broadcast to set top boxes or tuners of content receivers 18. As another possibility, the media content provider 14 may provide media content instances 12 over the Internet for download to the content receivers 18. While the communication network 16 is illustrated as being a single communication network 16, in some examples the communication network 16 may be implemented as multiple separate communication networks 16, such as a cable media content distribution network 16 serving the content receivers 18 and a separate communication network 16 serving the client devices 44. In other examples, both the content receivers 18 and other devices (e.g., the client devices 44) may be served by a common communication network 16.

The display devices 20 may be configured to display decoded media content instances 12 received from the content receivers 18. Exemplary display devices 20 may include televisions, computer monitors or other display terminals, as well as speakers or other audio reproduction devices. In some cases, the display devices 20 may be integrated into the content receivers 18 as integrated media playback devices (e.g., tablet computers, televisions, etc.), while in other cases the display devices 20 may be separate components from the content receivers 18 (e.g., set-top boxes in combination with display projector devices, personal computers with monitors, etc.). By using the display devices 20, the users of the system 10 may be able to perceive and experience the various aspects of the media content instances 12, such as audio and/or video content aspects.

The media content distributors 22 may provide the media content instances 12, such as new or existing television programming or films, to the media content provider 14 to be provided over the communication network 16 for viewing on display devices 20 associated with content receivers 18. As one possibility, the media content distributors 22 may distribute media content instances 12 to an over-the-air broadcast media content provider 14 (such as a television transmitter) to be broadcast to content receivers 18 using over-the-air radio-frequency signals. Alternatively, the media content instances 12 may be provided by the media content distributor 22 through other communication network 16 distribution channels, such as a via cable head end or a satellite network.

A significant portion of funding for media content providers 14 (e.g., private television networks) may be obtained from vendors 24 in the form of advertising revenue for products and services. For example, organizations often market products or services with commercial advertisements that air during breaks in regular television programming. In exchange for the commercial advertising time, the vendors 24 may pay the media content providers 14.

Some vendors 24 also advertise through product placement in feature programming. Product placement is an embedded marketing technique used by companies to subtly (or overtly) promote their products through non-traditional advertising means, usually through appearances in film, television, or other media. Product placements are often initiated through an agreement between advertising vendors 24 and media content providers 14, in which media content providers 14 receives economic benefit in exchange for providing the product placements in the media content instances 12. A vendor 24 may pay a fee to have its product used, displayed, or significantly featured in a movie or television show. Using television feature programming as an example, several products or items may be placed in each scene of an episode, such as clothing, accessories, furniture, appliances, vehicles, and the like. In the absence of conspicuous branding, it may be difficult for viewers of a media content instance 12 to identify the source of items that the viewers may wish to obtain additional information about and potentially purchase.

The inspector server 26 may be configured to identify, maintain and provide information regarding products that may be placed within media content instances 12. For example, the inspector server 26 may maintain unique scene identifiers 28 of scenes of a plurality of media content instances 12. The inspector server 26 may further maintain one or more representative images 30 of the scene indexed according to scene identifier 28, as well as unique item identifiers 32 and detailed item information 34 regarding products included in the representative image 30 of the scene of the media content instance 12. Each item may be associated with an item identifier 32 (e.g., storekeeper unit (SKU), universal product code (UPC), etc.). The inspector server 26 may maintain or access a database or other data store including information that identifies media content instances 12, episodes and/or scene identifiers 28 in which the items identified by the item identifiers 32 are included. In some cases, the representative image 30 may include one or more screen captures of frames of the scene in which the products are included, while in other cases, the representative image 30 may be another illustration of the scene suitable for illustrating the included products (such as a collection of the included products placed in combination). The item information 34 may include data such as: coordinates within the representative image 30 at which the product described by the item information 34 is included, a name of the product, a brand of the product, a vendor associated with the product, a price of the product, one or more images of the product including in some cases a default image, one or more related item identifiers 32, a description of the product, and a description of how the product appears or by what character it is used in the media content instance 12.

The inspector server 26 may include various modules that provide or support the various application functions or services. Although one example of the modularization of the inspector server 26 is illustrated and described, it should be understood that the operations thereof may be provided by fewer, greater, or differently named modules.

An interface module 36 of the inspector server 26 may be configured to support the exchange of data between the inspector server 26 and client devices 44. For instance, the interface module 36 may be configured to receive requests for information regarding media content instances 12 (e.g., including captured audio and/or video content), and may provide responses to the client requests including representative images 30 and item information 34.

In one or more embodiments, before a media content instance 12 containing an item is published (e.g., before an episode is aired on TV), the inspector server 26 may receive an advance copy of an episode for a TV program, for example, from the media content distributors 22 (e.g., the production company). Using the received advance copies, a scene indexing module 38 of the inspector server 26 may be configured to parse each media content instance 12 into a number of scenes (or to identify a pre-existing scene encoding of the media content instances 12), and to generate digital audio and/or video fingerprints of the received media content instances 12. A digital fingerprint for each scene in each analyzed media content instance 12 may be stored in a database or other data store of the inspector server 26 with its corresponding identification information, such as one or more of scene identifier 28, media content instance 12 identifier, or episode identifier, as some examples.

The inspector server 26 may include a scene identification module 40 configured to decode the captured media content and identify the scene and corresponding media content instance 12. When a portion of a captured instance of media content 12 is received, the scene identification module 40 of the inspector server 26 may convert the clip into a digital signature using the same (or a compatible) fingerprinting method. The scene identification module 40 may further search the database for a pattern match for the scene fingerprint to retrieve a scene identifier 28 or other identifiers corresponding to the received portion of the media content instance 12.

As another possibility, the media content distributor 22 or scene indexing module 38 may employ a post-production software plug-in (e.g., the After Effects plug-in distributed by Adobe Systems Incorporated of San Jose, Calif.) to embed messages into a media content instance 12. The embedded messages or code may not be discernible to a viewer or otherwise disrupt the viewing experience. However, the embedded messages can be captured by a video capture device and decoded with embedded message retrieval software. For example, using post-production software, video brightness patterns may be encoded into the media content instance 12 which may be used by the scene identification module 40 to identify a specific scene of a portion media content instance 12.

As another possibility, instead of making use of the scene indexing module 38 and scene identification module 40, the inspector server 26 may employ a third-party service that provides automatic content recognition (ACR) services to identify media content instances 12 from captured portions of media content instances 12 and scene identifiers 28.

In some cases, the scene identification module 40 may attempt to identify the scene using multiple components of the media content instance 12. For instance, the scene identification module 40 may attempt to identify audio and video components of the media content instance 12 at substantially the same time, such that the scene may be identified by whichever identification of the media content instance 12 identifies a scene first.

The inspector server 26 may include an item identification module 42 configured to maintain an item database indicative of which items are included in which scenes of the media content instances 12. As mentioned above, the inspector server 26 may receive advanced copies of supported media content instances 12 (such as TV episodes) from a media content distributor 22. The advance copy may further include or be accompanied by a list of items used in the episode. As one possibility, a list of items may be provided by the media content distributors 22 in a spreadsheet containing the item title, item identifier 32, and a scene identifier 28. A production assistant or the vendor 24 may generate or otherwise provide the item list for each media content instance 12. The item identifier 32 may be a SKU or UPC for the item, as some examples. Based on the received information, the item identification module 42 may be configured to update a database or other data store to index for later lookup the item identifiers 32 and item information 34 according to scene identifier 28.

The client device 44 may be a personal computer, a portable computer, a personal digital assistant (PDA), mobile phone, tablet device, a microprocessor-based entertainment appliance, a peer device or other common network node. The client device 44 may be configured to execute programs (e.g., a mobile app, a web browser, or the like) on one or more processors, where the programs are stored on one or more memory devices of the client device 44. The client device 44 may further include network hardware configured to allow the client device 44 to communicate with the inspector server 26 over the communication network 16. The client device 44 may also include input hardware 46 configured to receive input to be provided to the client devices 44. Exemplary input hardware 46 may include still cameras and video cameras for capturing video input, microphones for capturing audio input, and one or more buttons or other user controls for capturing input from a user of the client device 44. The client device 44 may also include output hardware 48 such as one or more displays to provide visual output, one or more speakers to provide audio output, and one or more haptic devices to provide haptic feedback to users of the device. The input hardware 46 and output hardware 48 may be used by the client device 44 to provide a user interface 50 between the client device 44 and users of the device.

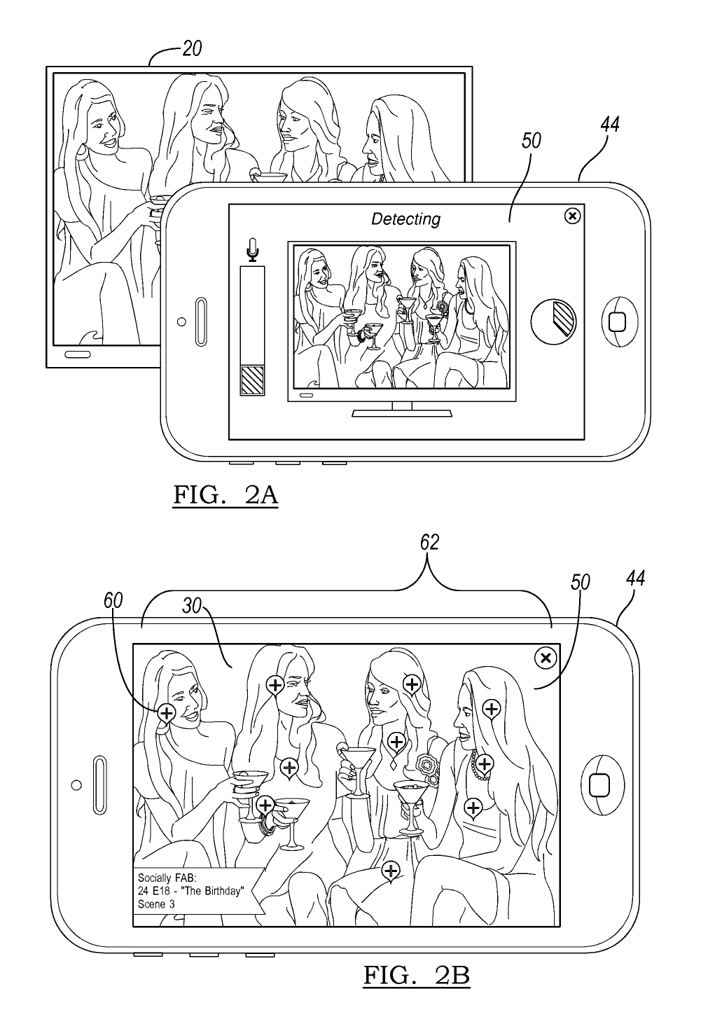

The inspector application 52 may be one example of an application program stored on a memory of the client device 44 (e.g., as software, firmware, etc.). In some cases, the inspector application 52 may be provided as a web-based application, while in other cases the inspector application 52 may be provided as a local application (e.g., shipped with the client device 44, downloaded from an application store to the client device 44, etc.). When executed by one or more processors of the client device 44, the inspector application 52 may be configured to cause the client device 44 to perform various operations related to the identification and purchase of items included within instances of media content 12. For example, the inspector application 52 may be configured to receive input from a user requesting for the client device 44 to utilize the input hardware 46 to capture a portion of a media content instance 12 being displayed by a display device 20. The inspector application 52 may be further configured to provide the captured portion to the inspector server 26, and to receive and present a representative image 30 corresponding to the identified scene, as well as an item overlay identifying at least one item of item information 34 included in the identified scene and available for purchase. Further aspects of the operation of the inspector application 52 are illustrated in FIGS. 2A-2D, discussed in detail below.

FIG. 2A illustrates a user interface 50 of an inspector application 52 capturing a portion of an instance of media content 12. For example, a user of a client device 44 experiencing an instance of media content 12 via a display device 20 may invoke the inspector application 52 because the user is interested in learning more about, and possibly purchasing, one or more products included in the media content 12. To retrieve information about the products, the user may use the inspector application 52 to capture a portion of an instance of media content 12. As one possibility, the user may point a video camera input hardware 46 device of the client device 44 in the direction of a display device 20 of a content receiver 18, and may invoke a record function of the user interface 50 to cause the inspector application 52 to begin to capture a portion of the displayed media content instance 12.

The inspector application 52 may accordingly capture video of the displayed media content instance 12 to allow the system 10 to identify the scene. Additionally or alternatively, the inspector application 52 may cause the client device 44 to capture the scene's audio output through a speaker display device 20 (not shown) using an audio capture input hardware 46, such as a microphone, provided in the client device 44. (If audio capture is being utilized, then alignment of the client device 44 to the display device 20 may be able to be relatively less precise, so long as the audio is of sufficient volume to be captured.) The inspector application 52 may further provide the captured portion of the media content instance 12 to the inspector server 26 for identification. In some cases, the inspector application 52 may capture a predefined period of the media content instance 12 (e.g., 3 seconds, 5 seconds, 10 seconds, etc.), while in other cases, the inspector application 52 may continue to capture and send the media content instance 12 to the inspector server 26 until a scene identifier 28 of the media content instance 12 is identified.

The representative image 30 associated with the scene identifier 28 may be received by the inspector application 52 upon scene identification by the inspector server 26 from the captured media content instance 12. In some examples, the inspector server 26 may provide the scene identifier 28 to the inspector application 52, and, if desired, the inspector application 52 may then query the inspector server 26 for the representative image 30, item identifiers 32 and/or item information 34 based on the scene identifier 28. In other examples, the inspector server 26 may send the representative image 30, item identifiers 32 and/or item information 34 without an additional query of the inspector server 26. If the scene identifier 28 is indicative of a scene from an unsupported media content instance 12 (e.g., a TV show for which no data is available to the inspector server 26 or a show that was not identified), the inspector application 52 may display an error message indicating that scene identification has failed or that additional product information content regarding the media content instance 12 is unavailable.

FIG. 2B illustrates an exemplary user interface 50 of an inspector application 52 including a representative image 30 and item overlay 62. The overlay 62 may be superimposed over or otherwise visible over the representative image 30 of the media content instance 12, and may include one or more interactive image tags 60, such that each interactive image tag 60 corresponds to a product that may be available for purchase from vendors (e.g., wardrobe items, furnishings, beverages, etc.). The interactive image tags 60 may be identified in the overlay 62 in various ways, such as by way of tagged or marked location indications superimposed on the representative image 30 at the locations in the overlay 62 where the items appear. Thus, each item in the representative image 30 available for sale may have a corresponding user interface element that is displayed on the display of the client device 44 in association with the purchasable item.

The inspector server 26 may be configured to serve content (e.g., HTML content, other marked-up content or raw representative image 30, item identifier 32 and item information 34 content) to the inspector application 52 to cause display of the one or more representative images 30 corresponding to the scene identifier 28 of the captured scene. In some examples, the overlay 62 may be received by the inspector application 52 as served content (e.g., as HTML or Adobe Flash elements), while in other examples, the overlay 62 may be generated by the inspector application 52 based on raw received item identifiers 32 or item information 34.

To facilitate the receipt of user input, each interactive image tag 60 of the overlay 62 may be associated with a corresponding item identifier 32 and may be selectable by a user of the inspector application 52. Using the inspector application 52, a user of the client device 44 may select an interface element associated with an item to bring up detailed item information 34 related to the selected interactive image tag 60.

FIG. 2C illustrates an exemplary user interface 50 of an inspector application 52 including an item information interface element 66. The item information interface element 66 may be displayed based on a user selection of an interactive image tag 60 from a displayed overlay 62. As some possibilities, the inspector application 52 may display the item information 34 in an item information interface element 66, such as an item widget, window control, a new screen or window, slide-out panel, or overlay.

For example, based on a user selection of an interactive image tag 60 from an overlay 62, the inspector application 52 may send an item identifier 32 corresponding to the interactive image tag 60 to the inspector server 26. In response, the inspector server 26 may transmit detailed item information 34 corresponding to the selected interactive image tag 60 to the inspector application 52 for display by the client device 44. As another example, the inspector application 52 may receive the detailed item information 34 along with the information for generation of the overlay 62, and may not require the additional query to the inspector server 26 based on the user selection of the interactive image tag 60.

The item information interface element 66 may display various aspects of the item information 34 for the selected item. As some examples, the item information interface element 66 may display one or more images of the item (e.g., a default image of the item), a price of the item, a name of the item, a description of the item.

The item information interface element 66 may further display images of related items. The related items displayed may be items that are (1) similar to the current item being viewed, (2) complementary to the current item being viewed, (3) frequently viewed or purchased alongside the current item being viewed, or the like. In some cases, related items may be determined by the inspector application 52 from a listing of related idem identifiers 32 included in the detailed item information 34 for a selected interactive image tag 60. Each related item may have its own corresponding related item interface element 68 for receiving selection input from a user. The related item interface element 68 may be a button or other link that opens a new item information interface element 66 for the selected related item upon receiving the selection input. The related image itself may be selectable as the related item interface element 68 or the related item interface element 68 may be a button adjacent the image.

The item information interface element 66 may also include “Add to Cart” button 70 or other widget that provides the user with the opportunity to purchase the item through the inspector application 52. Accordingly, users viewing a live or previously recorded show may make purchases of items they see in real-time as they are watching the show. Instead of wondering the origin of an item a user likes displayed within a media content instance 12, the user may purchase the item using the inspector application 52.

In some cases, a product may be unavailable through a vendor server 24 integrated into the system 10. In such a case the “Add to Cart” button 70 may be changed to or replaced with a “Buy Online” button 70 or “Find Online” button 70. If the “Buy Online” or “Find Online” button 70 is selected, the inspector application 52 may be configured to open a web browser window (e.g., inside the inspector application 52, by switching to an external web browser application, etc.) to navigate the user to a product page of a website that carries the product. The product may then be purchased by the user. In some cases, the web page may be that of a vendor 24 or affiliate retail partner, while in other cases the web page may be an external web site with no affiliation to the inspector server 26. If the retailer to which the user is referred is sold out, or the user desires to locate the product elsewhere, the inspector application 52 may further provide the user with the ability to find the product online using a search engine, e.g., in the opened internal or external web browser.

In yet further cases, rather than using a shopping cart, the inspector application 52 may utilize the “Buy Online” or “Find Online” buttons 70 for all or substantially all items, and may navigate the user to a product page on one of an affiliate vendor server 24 or retailer website. In such an approach, a link to an affiliate page may be used to allow the inspector application 52 to generate leads for the affiliate web pages for potential purchasers of the products.

Every item added to a shopping cart may be automatically saved in a database or other data store accessible by the inspector server 26 or inspector application 52, so that the user does not have to make purchases during the current application session. Further, a user may select a tag button 72 for any item the user chooses to add to a “wish” list, so that the user can quickly revisit the item at a later time or date.

The item information interface element 66 may also include one or more additional interface elements for enlarging a default item image, viewing an alternate item image, sharing the item using social media, sending a message including item information directly to a recipient, tagging the item for later review, or the like. The interface element for enlarging the default item image may be a zoom button 74. One or more alternate image buttons may cause an alternate view of the item to be prominently displayed within the item information interface element 66 in place of the default image. One or more social media buttons may be selected to post or otherwise share the item information and an optional message with one or more social network contacts. Additionally, a user may link a social media account to a “Friends” feature in the App to see what the user's friends are purchasing or browsing. The user may also send item suggestions with comments to specific social media contacts or friends. This may be accomplished using the one or more social media buttons 76 or a direct message button for sending a corresponding message to a recipient directly, as previously mentioned.

FIG. 2D illustrates an exemplary user interface 50 of the inspector application 52 including a shopping cart feature. As an example, the inspector application 52 may display a shopping cart interface element 78 such as a widget, window or panel. Similar to the item widget, the shopping cart widget may be a new screen or window, slide-out panel, image overlay such as that provided by the Lightbox overlay JavaScript distributed by Lokesh Dhakar, or the like. The inspector application 52 may be configured to display the shopping cart interface element 78 responsive to the addition of items to a shopping cart of the user (e.g., through use of the “Add to Cart” button 70 discussed above). Additionally or alternatively, the inspector application 52 may be configured to display the shopping cart interface element 78 when a shopping cart button (not shown) is selected.

The shopping cart interface element 78 may display item information 34 for each item added to the cart including, for example, an item image, item description and item price. The shopping cart interface element 78 may also display the quantity of each item in the shopping cart, as well as a subtotal of the cost for the entire cart. For each item in the shopping cart, the shopping cart interface element 78 may also include a remove item interface element for removing shopping cart item from the shopping cart and/or an edit interface element for editing the shopping cart item such as the item quantity to be purchased. The shopping cart interface element 78 may further include a checkout element 80. The checkout element 80 may be selected by users when they are ready to check out the items contained in their virtual shopping carts and complete the item purchases. In one or more embodiments, items sold through the inspector application 52 may be done using the inspector application 52 (e.g., using services provided by the vendor servers 24) so that users do not have to be redirected to third party websites or online stores for each item selected to be purchased. Users may accordingly check out, with multiple items selected from multiple shows, in one seamless checkout process.

With reference to FIGS. 2B-2D, the user interface 50 may further include a main task bar 82. The main task bar 82 may be a widget or other interface element that is present or accessible from every display screen. The main task bar 82 may be hidden at times, such as when a portion of a media content instance 12 is being captured as illustrated in FIG. 2A. The main task bar may include selectable user interface elements for activating various application features or functions. For instance, the main task bar 82 may include a capture button 86 (sometimes referred to as a detect button 86), a trending items button 88, a history button 90, a tagged item button 92, a social media button 94, a menu button 96, as some possibilities. The capture button 86 may activate the media capture functionality, as shown and discussed above with respect in FIG. 2A.

Upon selection of the history button 90, the user interface 50 may display a screen listing previously captured media content. The previously captured media content instances 12 may be organized in a number of ways using a number of different levels of organization. For instance, each media content instance 12 from which one or more scenes in an episode were captured may be listed. Selection of a show from the list may reveal a list of different episodes in which at least one scene was captured. The list may be further organized into seasons for each show if there are several episodes in the list from several seasons. Selection of an episode from the list of episodes may reveal a list of scenes from which audio and/or video content was captured and identified. Selection of a particular scene may cause the client device 44 to recall the one or more representative images 30 taken from the scene and the overlay 62 including interactive image tags 60 for each item in the scene tagged for sale. Varying levels of granularity of the capture history may be displayed by the client device 44 without departing from the scope of the present disclosure.

Upon selection of the tagged item button 92, the user interface 50 may display a listing or other showing of tagged items. The tagged items may, for example, those items for which a tag button 72 was used to add the item to a “wish” list, so that the user can quickly revisit the item at a later time or date. The tagged items may be selected such that detailed item information may be recalled and displayed, for example, in the item information interface element 66. Alternatively, a preview of each tagged item may be displayed in the showing of the tagged items (e.g., as a thumbnail of the default image for the corresponding item). The showing of the tagged items may also include functionality to add one or more of the tagged items to the shopping cart feature. Tagged items may also be individually or batch deleted using a delete user interface element or other function. Upon selection of the trending items button 88, the user interface 50 may display a listing of products that are currently popular with other users, with functionality similar to that of the listing of tagged items.

Upon selection of the social media button 94, the user interface 50 may display a screen listing social media contacts for a user of the inspector application 52. A user may link a social media account to the inspector application 52, such that once linked with a social media account, the user may see which social contacts are registered with the inspector server 26. The user interface 50 may provide the interface elements configured to allow the user to invite contacts in the social network of the user to registered with the inspector server 26. For the contacts that are registered, the user may see what the friends of the user are purchasing or browsing. The user may also send item suggestions with comments to specific social media contacts or friends.

By selecting the menu button 96, the interface module 36 may display a menu of additional application features not present on the main task bar 82. As some examples, these features may include application settings, user account information and settings, application information, and a listing of supported media content instances 12 (e.g., supported shows and movies).

In addition to or instead of buttons or other display elements, features of the inspector application 52 may be manipulated using hand gestures including multi-touch for client devices 44 equipped with touch sensing surface such as a touchscreen or trackpad. For instance, the alternate item images or related item images may be retrieved by finger swipe gestures. Moreover, active images may be zoomed out or in using pinch and spread gestures, respectively.

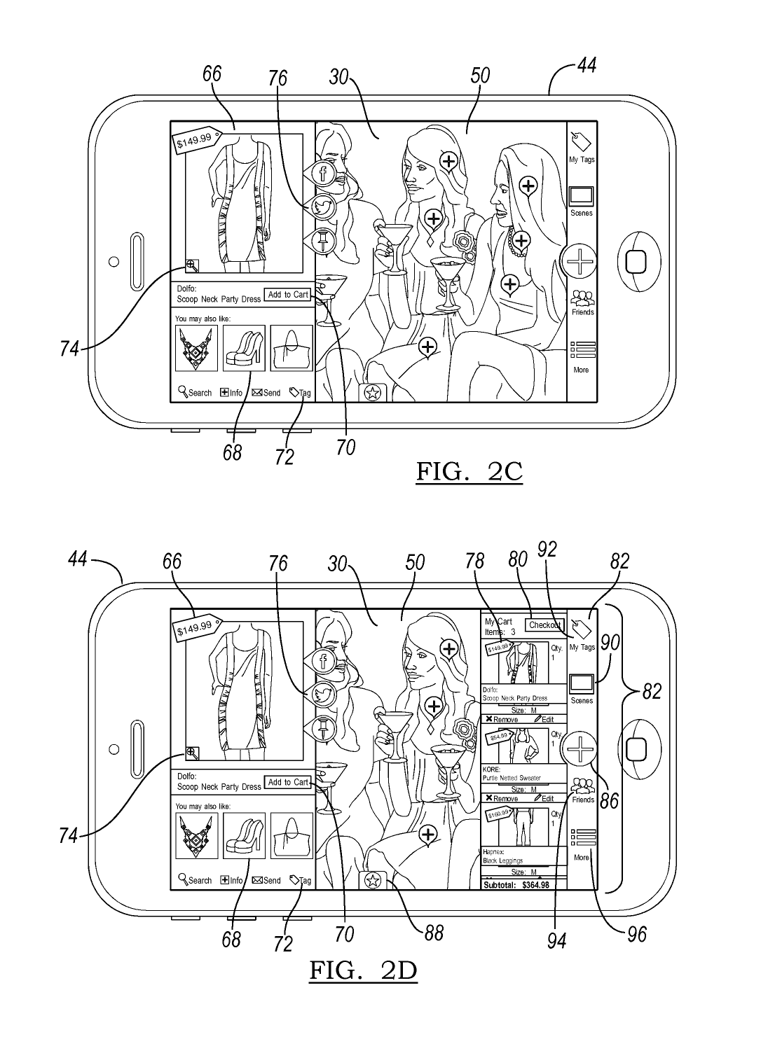

FIG. 3 illustrates an exemplary process 300 for providing information on products present in media content instances 12. The process 300 may be performed, for example, by an inspector server 26 in communication over a network 16 with an inspector application 52 executed by a client device 44.

At block 302, the inspector server 26 receives a portion of a media content instance 12 captured by the inspector application 52. For example, a user of a client device 44 experiencing an instance of media content 12 via a display device 20 may invoke the inspector application 52 because he or she is interested in learning more about and possibly purchasing one or more products included in the media content 12. To retrieve information about the products, the user may use the inspector application 52 to capture a portion of an instance of media content 12. The portion of the media content instance 12 may be received by the inspector server 26 from the client device 44.

At decision point 304, the inspector server 26 attempts to identify a scene. For example, the inspector server 26 may include a scene identification module 40 configured to decode the captured portion of the media content instance 12 and identify a scene identifier 28 and corresponding media content instance 12 from the received portion. As one possibility, the scene identification module 40 of the inspector server 26 may convert the captured portion of the media content instance 12 into a digital signature using a fingerprinting method, and may search a database of fingerprints for the scene fingerprint to retrieve a scene identifier 28 or other identifiers corresponding to the received portion of the media content instance 12. As another possibility, the scene identification module 40 may be configured to identify a specific scene identifier 28 from the portion media content instance 12 by identifying video brightness patterns encoded into the media content instance 12 using post-production software. As yet a further possibility, the inspector server 26 may employ a third-party service that provides automatic content recognition (ACR) services to identify media content instances 12 from captured portions of media content instances 12 and scene identifiers 28. If the scene is identified, then control passes to block 306. Otherwise, if the scene is not identified, then control passes back to block 302 to, for example, retrieve an additional portion of the media content instance 12.

At block 306, the inspector server 26 retrieves scene information based on the scene identifier 28 identified for the scene. For example, the inspector server 26 may be configured to utilize the item identification module 42 may be configured to retrieve item identifiers 32 and item information 34 indexed according to scene identifier 28 in a database or other data store. Additionally, the inspector server 26 may further retrieve the representative image 30 based on the scene identifier 28. In some examples, the inspector server 26 may provide the scene identifier 28 to the inspector application 52, and, if desired, the inspector application 52 may then query the inspector server 26 for the representative image 30, item identifiers 32 and item information 34 based on the scene identifier 28. In other examples, the inspector server 26 may send the representative image 30, item identifiers 32 and/or item information 34 without an additional query of the inspector server 26. As another possibility, if the scene is identified as being unsupported (e.g., no image or item content is available), the inspector server 26 may return a message indicating the unsupported nature of the media content instance 12, and the process 300 may end.

At block 308, the inspector server 26 provides representative images 30 and item identifiers 32 to be included in an item overlay 62. The representative images 30 and item information 34 may be provided to the inspector application 52 of the client device 44 responsive to receipt and identification of the portion of the media content instance 12. After block 308, the process 300 ends.

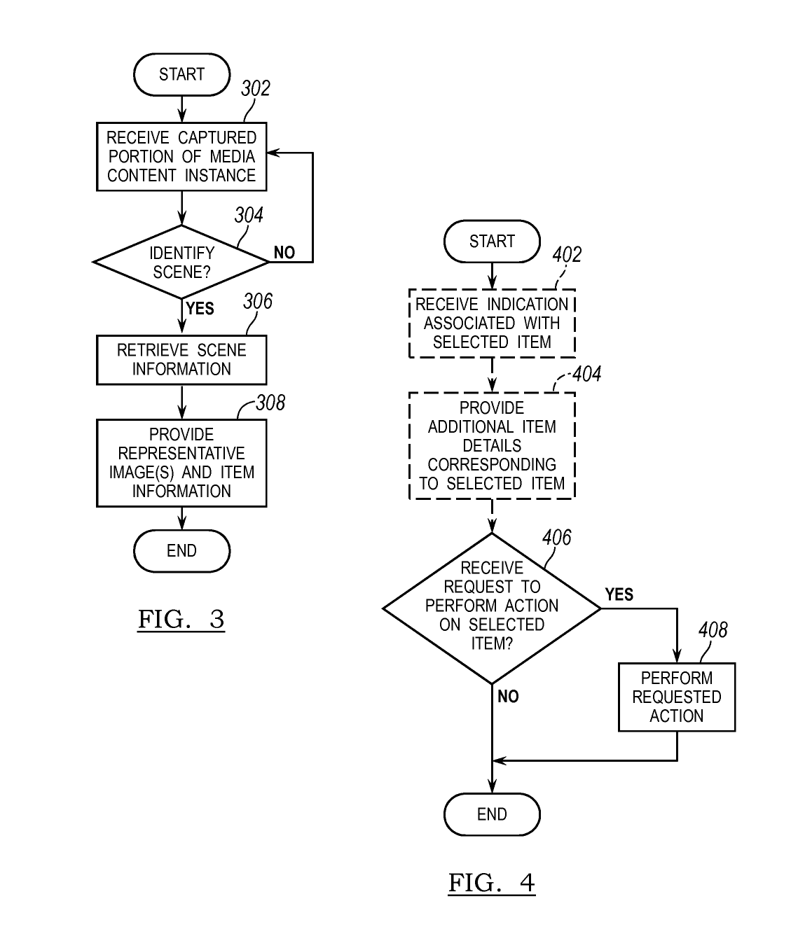

FIG. 4 illustrates an exemplary process 400 for performing actions on products present in media content instances 12. As with the process 300, the process 400 may be performed, for example, by an inspector server 26 in communication over a network 16 with an inspector application 52 executed by a client device 44.

At block 402, in cases where the item information 34 is not provided by the inspector server 26 in block 308, the inspector server 26 optionally receives an item identifier 32 associated with a selected interactive image tag 60 to receive detailed item information 34 about the selected item.

At block 404, the inspector server 26 provides the additional detailed item information 34 responsive to the optional request.

At decision point 406, the inspector server 26 determines whether to perform an action on a selected item. For example, the inspector server 26 may receive one or more command request from the inspector application 52 requesting actions to be performed on a selected item identified according to item identifier 32. As one possibility, the inspector server 26 may receive a command request to add a selected item to a shopping cart (e.g., upon receiving an indication of a user invoking an “Add to Cart” button 70 or similar widget that provides the user with the opportunity to purchase the item through the inspector application 52). As another possibility, the inspector server 26 may receive a command request to navigate the user to a product page of a website that carries the product (e.g., upon receiving an indication of a user invoking a “Buy Online” or “Find Online” button 70 that provides the user with the opportunity to purchase the item from a website). As additional possibilities, the inspector server 26 may receive a command request to share the item using social media, send a message including item information 34 to a recipient, or tag the item for later review. If the inspector server 26 determines to perform a command, control passes to block 408. Otherwise control remains at decision point 406.

At block 408, the inspector server 26 performs the requested action based on the provided item identifier 32. As one possibility, the inspector server 26 may add the selected item to a shopping cart or otherwise allow a user to purchase the selected item (e.g., utilizing a vendor server 24 to complete the purchase of the selected items according to item identifier 32). As additional possibilities, the inspector server 26 may perform actions such as to share the item using social media, send a message including item information directly to a recipient, or tag the item for later review. After block 408, the process 400 ends. The process 400 may be performed additional times for additional requested actions.

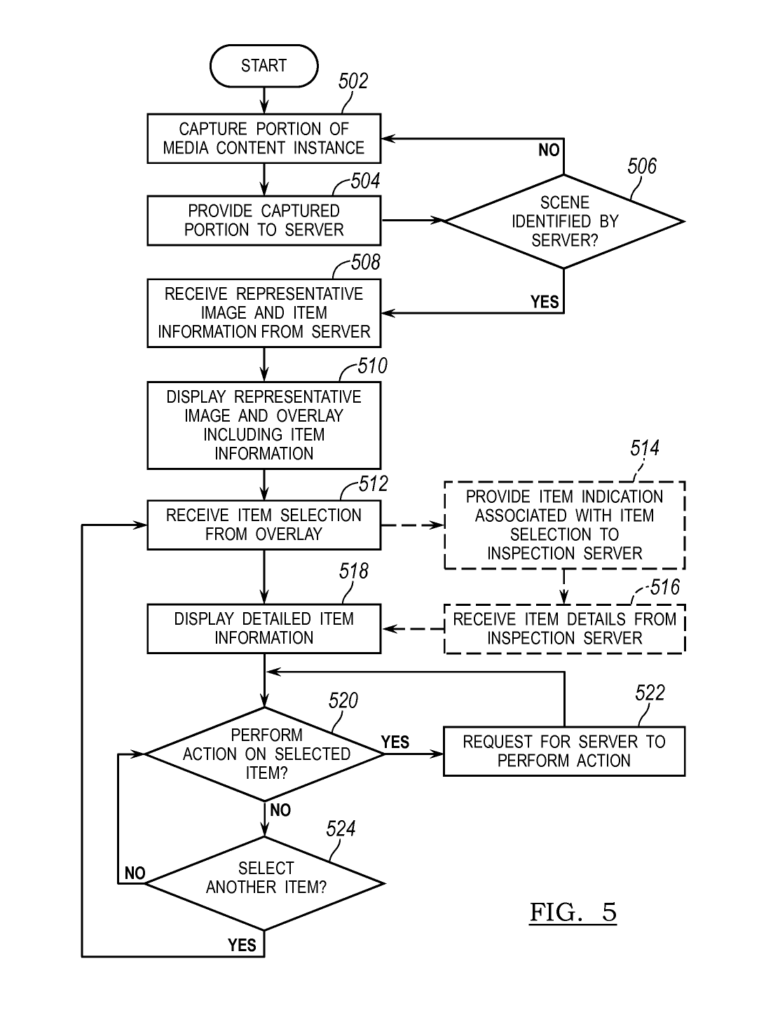

FIG. 5 illustrates an exemplary process 500 for identifying and performing actions on selected products present in media content instances 12 using a client device 44. As with the processes 300 and 400, the process 500 may be performed, for example, by an inspector server 26 in communication over a network 16 with an inspector application 52 executed by a client device 44.

At block 502, the client device 44 captures a portion of a media content instance 12. For example, as illustrated in FIG. 3A, a user of a client device 44 experiencing an instance of media content 12 via a display device 20 may invoke the inspector application 52 because he or she is interested in learning more about and possibly purchasing one or more products included in the media content 12. To retrieve information about the products, the user may use the inspector application 52 to capture a portion of an instance of media content 12. At block 504, the client device 44 provides the captured portion of the media content instance 12 to the inspector server 26.

At decision point 506, the client device 44 determines whether the scene was identified by the inspector server 26. For example, if the client device 44 receives a scene identifier 28 from the inspector server 26, the client device 44 may determine that the scene was identified. If the scene is identified, then control passes to block 508. Otherwise, if the scene is not identified, then control passes back to block 502 to, for example, retrieve an additional portion of the media content instance 12.

At block 508, the client device 44 receives one or more representative images 30 and item information from the inspector server 26. The representative images 30, item identifiers 32 and in some cases item information 34 may be received by the inspector application 52 of the client device 44 responsive to the identification of the portion of the media content instance 12.

At block 510, the client device 44 displays a representative image 30 and item information. For example, as illustrated in FIG. 3B, an exemplary user interface 50 of an inspector application 52 may include a representative image 30 and an item overlay 62. The overlay 62 may be superimposed over or otherwise visible over the representative image 30 of the media content instance 12, and may include one or more interactive image tags 60, such that each interactive image tag 60 is located at a position in the image 30 corresponding to a displayed product that may be available for purchase from the vendors 24 (e.g., wardrobe items, furnishings, beverages, etc.). The interactive image tags 60 may be identified in the overlay 62 in various ways, such as by way of tagged or marked location indications superimposed on the representative image 30. Thus, each item in the representative image 30 available for sale may have a corresponding user interface element that is displayed on the display of the client device 44 in association with the purchasable item.

At block 512, the client device 44 receives an item selection based on the received item information. For example, each interactive image tag 60 of the overlay 62 may be associated with a corresponding item identifier 32 and may be selectable by a user of the inspector application 52. Using the inspector application 52, a user of the client device 44 may select an interface element associated with an item, e.g., to bring up detailed item information 34 related to the selected interactive image tag 60.

At block 514, the client device 44 optionally provides an item identifier 32 of a selected item to the inspector server 26 to receive detailed item information 34. At block 516, the client device 44 receives the detailed item information 34 from the inspector server 26.

At block 518, the client device 44 displays the detailed item information 34. For example, as illustrated in FIG. 3B, an item information interface element 66 may be displayed based on a user selection of an interactive image tag 60 from a displayed overlay 62. As some possibilities, the inspector application 52 may display the item information 34 in an item information interface element 66, such as an item widget, window control, a new screen or window, slide-out panel, or overlay. The item information interface element 66 may display various aspects of the item information 34 for the selected item. As some examples, the item information interface element 66 may display one or more images of the item (e.g., a default image of the item), a price of the item, a name of the item, a description of the item.

At decision point 520, the client device 44 determines whether to perform an action on the selected item. For example, the client device 44 may receive one or more user interface actions requesting actions to be performed on a selected item identified according to item identifier 32. As one possibility, the client device 44 may receive a user interface action to add a selected item to a shopping cart (e.g., upon receiving an indication of a user invoking an “Add to Cart” button 70 or similar widget that provides the user with the opportunity to purchase the item through the inspector application 52). As another possibility, the client device 44 may receive a user interface action to navigate the user to a product page of a website that carries the product (e.g., upon receiving an indication of a user invoking a “Buy Online” or “Find Online” button 70 that provides the user with the opportunity to purchase the item from a website). As additional possibilities, the client device 44 may receive a user interface action from a user requesting to share the item using social media, send a message including item information 34 to a recipient, or tag the item for later review. If the client device 44 determines to perform a command, control passes to block 522. Otherwise control passes to decision point 524.

At block 522 the client device 44 requests the action to be performed by the inspector server 26. For example, the client device 44 may send a command to the inspector server 26 to request for the inspector server 26 to perform the action. As one possibility, the command may request for the inspector server 26 to add the selected item to a shopping cart or otherwise allow a user to purchase the selected item (e.g., using the services of the vendor server 24). As additional possibilities, the command may request for the inspector server 26 to perform actions such as to share the item using social media, send a message including item information directly to a recipient, or tag the item for later review. After block 522, control passes to decision point 520.

At decision point 524, the client device 44 determines whether another item has been selected. For example, using the inspector application 52, a user of the client device 44 may select an interface element associated with another item, e.g., to bring up detailed item information 34 related to the selected interactive image tag 60. If so, control passes to block 512. Otherwise control passes to decision point 520.

It should be noted that the processes of FIGS. 3-5 as described herein is exemplary only, and that the functions or steps of the method could be undertaken other than in the order described and/or simultaneously as may be desired, permitted, and/or possible.

It should be noted that one or more embodiments of the present disclosure can be implemented in software and/or in a combination of software and hardware, e.g., using application specific integrated circuits (ASIC), a general purpose computer or any other hardware equivalents. For example, computer-readable instructions pertaining to the method(s) discussed above can be used to configure a hardware processor to perform the steps, functions and/or operations of the above-disclosed methods. In one or more embodiments, the modules or processes for providing an inspector server 26 and inspector application 52 can be implemented as computer-executable instructions (e.g., a software program comprising computer-executable instructions) and loaded into memory and executed by processor to implement the steps, functions and operations as discussed above. As such, the modularization for providing the inspector server 26 (including associated data structures) of the present disclosure may be stored on a non-transitory (e.g., tangible and physical) computer readable storage medium, such as RAM memory, magnetic or optical drive or diskette, and the like. In this regard, it should be noted that any one or more of the devices described in connection with the present disclosure may be embodied by the system 10.

While exemplary embodiments are described above, it is not intended that these embodiments describe all possible forms of the invention. Rather, the words used in the specification are words of description rather than limitation, and it is understood that various changes may be made without departing from the spirit and scope of the subject matter presented herein. Additionally, the features of various implementing embodiments may be combined to form further embodiments of the present disclosure.

What is claimed is:

1. A system comprising:
an inspector server configured to perform operations comprising:
receiving a client request including a portion of a media content instance captured by a client device;
identifying a scene of the media content instance that includes the portion of the media content instance; and
providing, to the client device responsive to the request, a representative image corresponding to the scene and item information including identifiers of at least one item in the scene available for purchase and locations of the items in the representative image.

2. The system of claim 1, the inspector server further configured to perform operations comprising:
receiving, from the client device, a request including an item identifier associated with one of the at least one item included in the scene; and
providing detailed item information corresponding to the item identifier responsive to the request.

3. The system of claim 1, the inspector server further configured to perform operations comprising:
receiving, from the client device, a request to purchase an item, the item being identified by an item identifier associated with one of the at least one item included in the scene; and
performing the purchase of the item responsive to the request.

4. The system of claim 1, the inspector server further configured to perform operations comprising:
receiving, from the client device, a request to purchase an item, the item being identified by an item identifier associated with one of the at least one item included in the scene; and
providing, responsive to the request, a web address to a retailer website from which the item is available for purchase.

5. The system of claim 1, wherein the portion of a media content instance captured by a client device includes video content captured using a video capture component of a client device.

6. The system of claim 1, wherein the portion of a media content instance captured by a client device includes audio content captured using an audio capture component of the client device.

7. The system of claim 1, the inspector server further configured to perform identifying the scene of the media content instance by comparing a digital signature fingerprint of the portion of the media content instance with digital signature fingerprints of scenes of supported media content instances.

8. The system of claim 1, the inspector server further configured to perform identifying the scene of the media content instance by comparing embedded brightness information of the portion of the media content instance with brightness information identifying scenes of supported media content instances.

9. The system of claim 1, the inspector server further configured to perform identifying the scene of the media content instance by employing a third-party service to identify the portion of the media content instance.

10. The system of claim 1, wherein the portion of a media content instance captured by a client device includes audio content captured using an audio capture component of the client device and video content captured using a video capture component of a client device, and further comprising identifying the scene of the media content instance by substantially simultaneously decoding a video brightness pattern in the captured video and an audio frequency pattern in the captured audio to obtain decoded data identifying the scene.

11. A system comprising:
a client device configured to execute an inspector application on a processor of the client device to cause the client device to perform operations comprising:
providing a portion of a scene of a media content instance captured by the client device to an inspector server;
receiving a representative image corresponding to the scene and item information including identifiers of at least one item in the scene available for purchase and locations of the items in the representative image; and
displaying the representative image and an overlay visible over the representative image, the overlay including interactive image tags corresponding to items available for purchase and presented at respective locations in the representative image where the items available for purchase appear.

12. The system of claim 11, the client device further configured to execute the inspector application to perform operations comprising:
providing a request including an indication of selection of an interactive image tag of the overlay, the interactive image tag being associated with one of the at least one item included in the scene; and
receiving detailed information regarding the one of the at least one item included in the scene responsive to the request.

13. The system of claim 11, the client device further configured to execute the inspector application to perform operations comprising providing a request to purchase an item, the item being identified by an item identifier associated with one of the at least one item included in the scene.

14. The system of claim 11, the client device further configured to execute the inspector application to perform operations comprising instructing a video capture component of the client device to capture video content of the media content instance.

15. The system of claim 11, the client device further configured to execute the inspector application to perform operations comprising instructing an audio capture component of the client device to capture audio content of the media content instance.

16. A non-transitory computer-readable medium containing instructions that when executed by a processor of a device cause the device to perform operations comprising:
providing a portion of a scene of a media content instance captured by the device to an inspector server;
receiving a representative image corresponding to the scene and item information including identifiers of at least one item in the scene available for purchase and locations of the items in the representative image; and
displaying the representative image and an overlay visible over the representative image, the overlay including interactive image tags corresponding to items available for purchase and presented at respective locations in the representative image where the items available for purchase appear.

17. The non-transitory computer-readable medium of claim 16, further containing instructions that when executed by a processor of a device cause the device to perform operations comprising:
providing a request including an indication of selection of an interactive image tag of the overlay, the interactive image tag being associated with one of the at least one item included in the scene; and
receiving detailed information regarding the one of the at least one item included in the scene responsive to the request.

18. The non-transitory computer-readable medium of claim 16, further containing instructions that when executed by a processor of a device cause the device to perform operations comprising providing a request to purchase an item, the item being identified by an item identifier associated with one of the at least one item included in the scene.

19. The non-transitory computer-readable medium of claim 16, further containing instructions that when executed by a processor of a device cause the device to perform operations comprising instructing a video capture component of the device to capture video content of the media content instance.

20. The non-transitory computer-readable medium of claim 16, further containing instructions that when executed by a processor of a device cause the device to perform operations comprising instructing an audio capture component of the device to capture audio content of the media content instance.
